(19) United States
(12) Patent Application Publication
(10) Pub. No.: US 2005/0136717 A1
(43) Pub. Date: Jun. 23, 2005

(54) Dismountable power outlet

(75) Inventor: Tsang Lai, Taipei City (TW)

Correspondence Address: Touch Electronic Co., Ltd., P.O. Box No. 6-57, Junghe, Taipei, 235, TW

(73) Assignee: Touch Electronic Co., Ltd., Tucheng City (TW)

(21) Appl. No.: 10/737,967

(22) Filed: Dec. 18, 2003

(51) Int. Cl. H01R 29/00

(52) U.S. Cl. 439/170

(57) ABSTRACT

A dismountable power outlet, structurally characterized in that upon inserting a connecting plug into a receptacle an insertion pin is passed through a slot opening and thereon into the receptacle, thereafter the insertion pin slots into an insertion slot of the connecting plug, at the same time metal pins of the receptacle lodge into joint holes of the connecting plug, and therewith enables flow of an electrical current. Furthermore, upon joining together the connecting plug and the receptacle, reverse connecting is prevented through an anti-reverse connection device devised from a protrusion configured on the receptacle and a hollow defined in the connecting plug.

### BACKGROUND OF THE INVENTION

(a) Field of the Invention

The present invention related to a dismountable power outlet, more particularly to a power outlet enabled with flow of an electrical current.

(b) Description of the Prior Art

Referring to FIG. 1, which shows a conventional dismountable power outlet A comprising a receptacle A1 and a connecting plug A2. The receptacle A1 and the connecting plug A2 are assembled by utilizing a slide groove of the receptacle A1 and a slide track of the connecting plug A2. The connecting plug A2 utilizes a metal spring piece to achieve functionality to conduct an electrical current. However, after a period of usage, fatigue in resilience of the metal spring piece results, thereby procuring a poor contact and thus preventing an electrical current from flowing.

Furthermore, the fastening configuration of the connecting plug A2 and the receptacle A1 utilizes the resilience of the metal spring piece to tenon into the receptacle A1. However, a comparatively large effort is required when dismantling the dismountable power outlet A in order to replace the connecting plug A2, thereby causing inconvenience when in usage.

Thus, inherent technical difficulties involved in eliminating the aforementioned shortcomings are those which the inventor of the present invention intends to resolve.

### SUMMARY OF THE INVENTION

The present invention is to provide a dismountable power outlet, which is structurally characterized in that upon inserting a connecting plug into a receptacle an insertion pin is passed through a slot opening and thereon into the receptacle, thereafter the insertion pin slots into an insertion slot of the connecting plug, at the same time metal pins of the receptacle lodge into joint holes of the connecting plug, and flow of an electrical current is enabled therewith.

Furthermore, upon joining together the connecting plug and the receptacle, reverse connecting is prevented through an anti-reverse connection device devised from a protrusion configured on the receptacle and a hollow defined in the connecting plug.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded elevational view of a conventional dismountable power outlet.

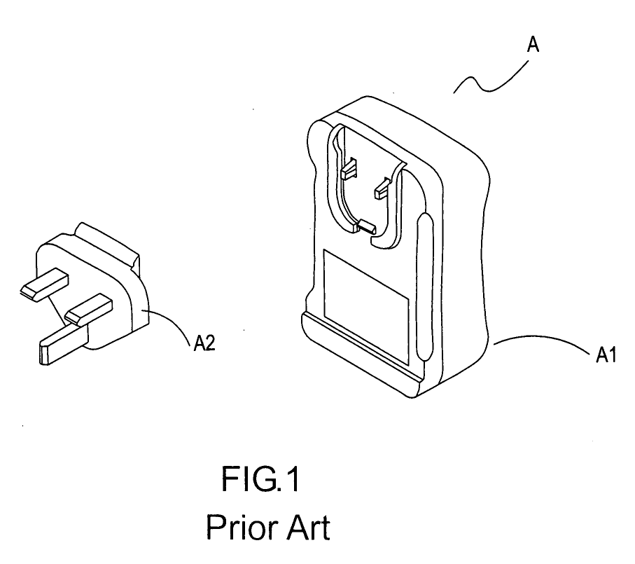

FIG. 2 shows an elevational view according to the present invention.

FIG. 3 shows an exploded elevational view according to the present invention.

FIG. 4 shows an elevational view of a connecting plug according to the present invention.

FIG. 5 shows a cross sectional schematic view of the connecting plug being inserted into a receptacle according to the present invention.

FIG. 6 shows an elevational view of further embodiments according to the present invention.

### DETAILED DESCRIPTION OF THE PREFERRED EMBODIMENTS

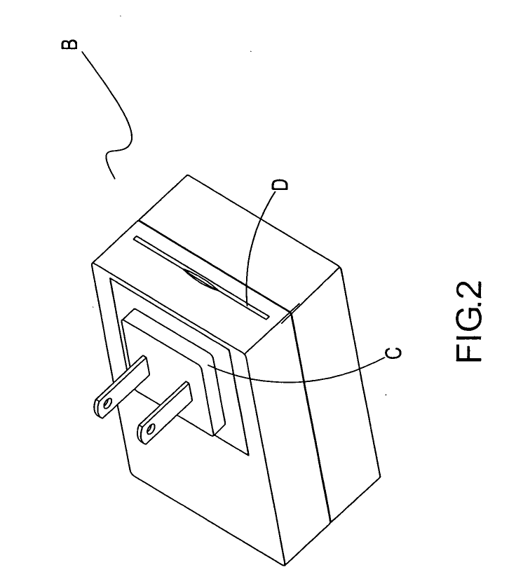

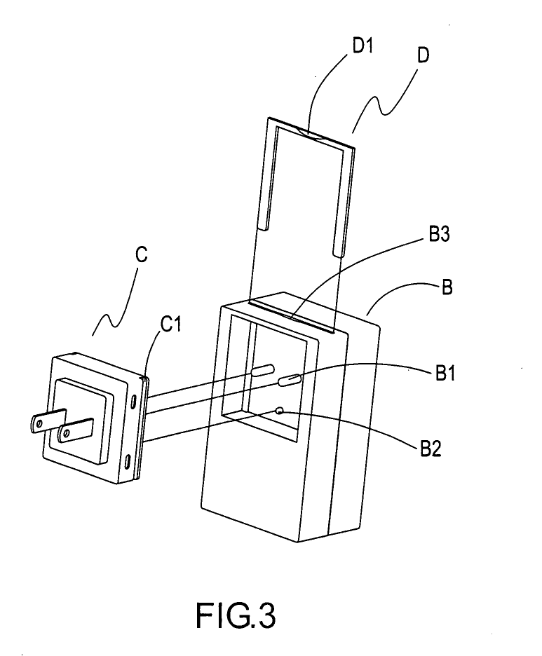

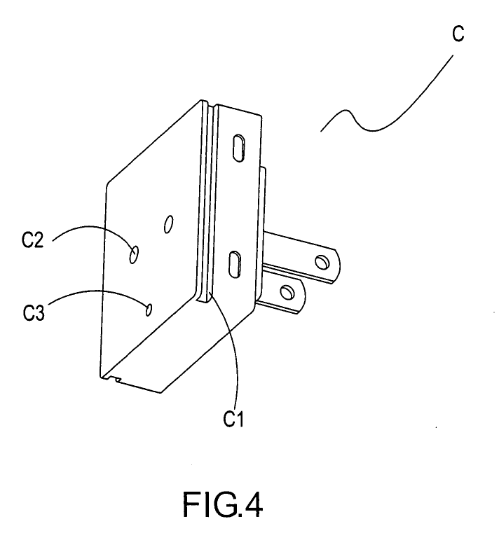

Referring to FIGS. 2, 3 and 4, which show a dismantle able power outlet of the present invention comprising and constructed to include a receptacle B and a connecting plug C, whereby the receptacle B is configured with metal pins B1, a protrusion B2 and a slot opening B3, and the connecting plug C is configured with an insertion slot C1, joint holes C2 and a hollow C3;

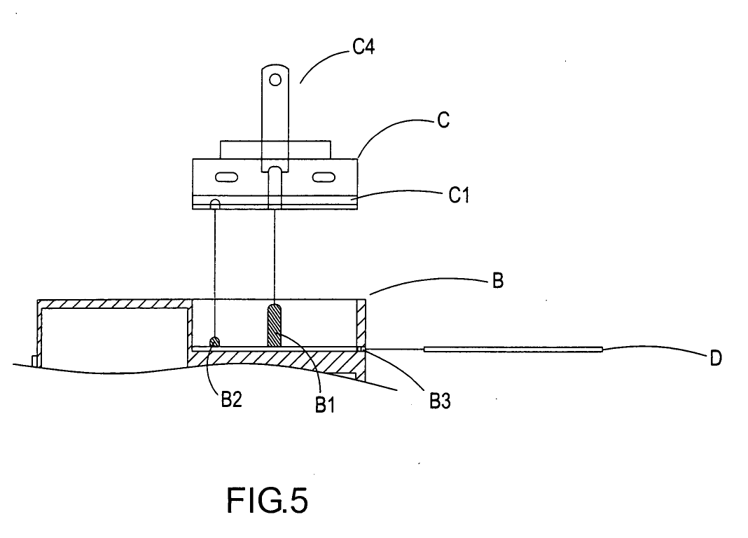

The dismantle able power outlet of the present invention provides is structurally characterized in that (see FIG. 5) upon inserting the connecting plug C into the receptacle B an insertion pin D is passed through the slot opening B3 and thereon into the receptacle B, thereafter the insertion pin slots into an insertion slot C1 of the connecting plug C, at the same time the metal pins B1 of the receptacle B lodge into the joint holes C2 of the connecting plug C, and flow of an electrical current is enabled therewith.

Furthermore, upon joining together the connecting plug C and the receptacle B, reverse connecting is prevented through an anti-reverse connection device devised from a protrusion B2 configured on the receptacle and a hollow C3 defined in the connecting plug.

The insertion pin D is further configured with an indentation D1, whereby pulling out of the insertion pin D when dismantling and replacing the connecting plug C is benefited therewith.

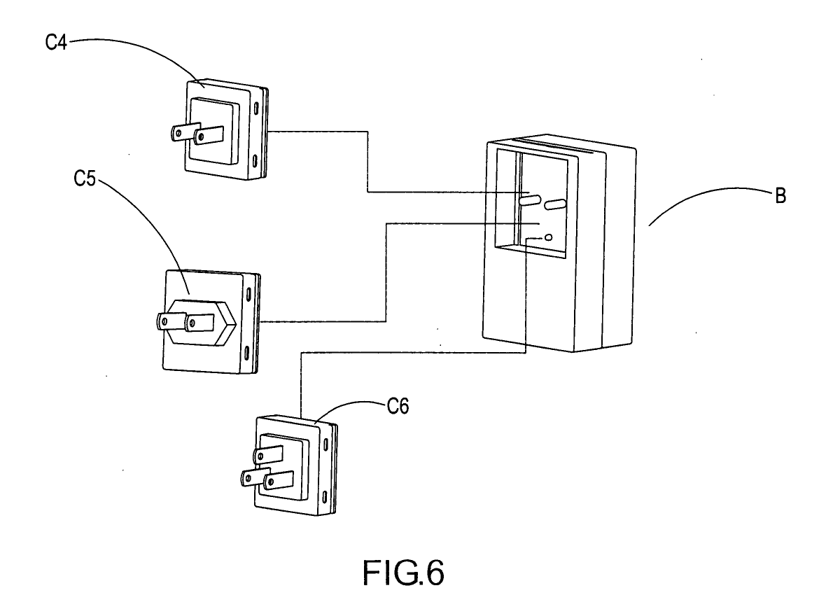

Referring to FIGS. 5 and 6, which show an embodiment of the present invention providing a dismountable power outlet, whereby after inserting the connecting plug C into the receptacle B an insertion pin D is passed through a slot opening B3 and thereon into the receptacle B, thereafter the insertion pin slots into an insertion slot C1 of the connecting plug C, at the same time metal pins B1 of the receptacle B lodge into joint holes C2 of the connecting plug C, and flow of an electrical current is enabled therewith.

Upon joining together the connecting plug C and the receptacle B, because of an anti-reverse connection device devised from a protrusion B2 configured on the receptacle and a hollow C3 defined in the connecting plug, a user is prevented from reverse connecting the connecting plug C, thereby achieving functionality of safety and convenience.

The connecting plug C can be replaced with different connecting plugs C4, C5, and C6 according to different places of usage, thereby benefiting compliance and usage with receptacles in different countries and of different specifications.

In order to present more clearly advancement and practicability of the present invention, a comparative analysis with a conventional dismountable power outlet is disclosed hereinafter:

Conventional shortcomings:
1. Dismantling of the connecting plug from the receptacle is difficult and troublesome to replace.
2. No configuration is provided to prevent reverse connecting, and thus easy to reverse connect the connecting plug and thereby cause burn out of an electrical appliance.
3. Fastening configuration easily loosens, and therefore hazardous when in use.

Advantages of the present invention:
1. Fastening configuration is compact and firm, and therefore averts anxiety about the connecting plug C coming apart when in usage.
2. Provided with quick dismantling of the connecting plug C and the receptacle B, thereby benefiting replacement of the connecting plug C when required.
3. Configured with the anti-reverse connecting device, which therewith prevents the user from reverse connecting the connecting plug C.
4. Provided with advancement, practicability and security.
5. Enhances industrial competitiveness.

In conclusion, the present invention has made a breakthrough in prior art structural configurations, and assuredly achieves functionality of advancement as intended. Moreover, the present invention as described herein is easily understood by those not acquainted with technical skills as disclosed. Furthermore, the present invention has not been made public prior to this patent application. Advancement and practicability of the present invention as disclosed clearly complies with conditions for application as required for a new model patent, accordingly, a patent application for a new model is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A dismountable power outlet, comprising a receptacle and a connecting plug, whereby:
the receptacle is configured with metal pins, a protrusion and a slot opening;
the connecting plug is configured with an insertion slot, joint holes and a hollow;
and is structurally characterized in that:
upon inserting the connecting plug into the receptacle an insertion pin is passed through the slot opening and thereon into the receptacle, thereafter the insertion pin slots into an insertion slot of the connecting plug, at the same time the metal pins of the receptacle lodge into the joint holes of the connecting plug, and therewith enables flow of an electrical current;
an anti-reverse connection device devised from the protrusion configured on the receptacle and the hollow defined in the connecting plug prevents reverse connecting of the connecting plug into the receptacle;
the insertion pin is further configured with an indentation, whereby pulling out of the insertion pin when dismantling and replacing the connecting plug is benefited therewith.
